(19) United States
(12) Patent Application Publication
(10) Pub. No.: US 2016/0037307 A1
(43) Pub. Date: Feb. 4, 2016

(54) VEHICLE-RELATED INFORMATION SHARING METHOD AND SYSTEM

(71) Applicant: General Motors, LLC, Detroit, MI (US)

(72) Inventor: Rebecca C. Roth, Novi, MI (US)

(21) Appl. No.: 14/448,693

(22) Filed: Jul. 31, 2014

(51) Int. Cl. H04W 4/04; H04W 4/00; H04W 4/12; H04L 12/58; H04L 29/08

(52) U.S. Cl. CPC H04W 4/046; H04L 51/08; H04L 67/1095; H04W 4/12; H04W 4/005

(57) ABSTRACT

In an example of a vehicle-related information sharing method, vehicle-related information is received at an in-vehicle application resident on a memory of a communications platform in a vehicle. The in-vehicle application identifies a mobile communications device to transmit a data package to, where the data package is associated with the vehicle-related information. The in-vehicle application recognizes that the mobile communications device has a vehicle-related application resident on a memory thereof and that the vehicle-related application has a rich message feature enabled. The in-vehicle application prepares the data package with vehicle-related action information and a phone number of the mobile communications device. The data package is transmitted from the in-vehicle application to the vehicle-related application first through a messaging server of a communications platform service provider and then through a proprietary messaging server of a proprietary messaging service of the mobile communications device.

### TECHNICAL FIELD

The present disclosure relates generally to vehicle-related information sharing methods and systems.

### BACKGROUND

Vehicles are often equipped with in-vehicle communications platforms (e.g., telematics unit and/or infotainment units) or other in-vehicle controllers that enable hands free calling, vehicle tracking, navigation instruction transmission, application downloads, and other like features. In-vehicle communications platforms or other in-vehicle controllers may connect to a cellular network and/or an Internet connection in order to enable these services/features.

### SUMMARY

In an example of a vehicle-related information sharing method, vehicle-related information is received at an in-vehicle application resident on a memory of a communications platform in a vehicle. The in-vehicle application identifies a mobile communications device to transmit a data package to, where the data package is associated with the vehicle-related information. The in-vehicle application recognizes that the mobile communications device has a vehicle-related application resident on a memory thereof and that the vehicle-related application has a rich message feature enabled. The in-vehicle application prepares the data package with vehicle-related action information and a phone number of the mobile communications device. The data package is transmitted from the in-vehicle application to the vehicle-related application first through a messaging server of a communications platform service provider and then through a proprietary messaging server of a proprietary messaging service of the mobile communications device.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic view of an example of a system for performing an example of a vehicle-related information sharing method; and

FIG. 2 is a schematic flow diagram illustrating various examples of the vehicle-related information sharing method.

### DETAILED DESCRIPTION

Some examples of an in-vehicle application disclosed herein advantageously respond to in-vehicle user requests by retrieving vehicle-related information that is responsive to the request, and by making the vehicle-related information available to a mobile communications device. Other examples of an in-vehicle application disclosed herein advantageously respond to in-vehicle notifications by providing the in-vehicle user with a vehicle-related action/cue that is responsive to the notification, and by making the vehicle-related action/cue available to a mobile communications device. This enables the user to receive information, action(s)/cue(s), etc. related to his/her vehicle, without having to use a search engine on the mobile communications device or on another remote computing device that may not provide accurate information for the specific vehicle. Additionally, having the information, action(s)/cue(s), etc. on the mobile communications device enables the user to take the vehicle-related (action) information outside of the vehicle. This may be desirable, for example, when the information relates to a task that takes place outside of the vehicle, such as changing a tire, replacing a head light, a tail light, a windshield wiper, etc., filling engine fluids, or the like.

In some of the example(s) disclosed herein, the in-vehicle application is capable of responding to the in-vehicle user request or the in-vehicle notification by transmitting rich message(s) (i.e., data package(s)) to the mobile communications device. The rich messages may include short messages containing vehicle specific content and/or action cues, web Uniform Resource Locators (URL) for vehicle-specific content, and/or mobile device commands for a vehicle-related application stored on the mobile communications device. The in-vehicle application is capable of i) identifying the mobile communications device, ii) recognizing that the mobile communications device has a vehicle-related application stored thereon, and iii) recognizing that a rich message feature of the vehicle-related application is enabled. In the examples disclosed herein, the vehicle-related application on the mobile communications device does not need to be running in order to receive the rich message(s) from the in-vehicle application.

In other example(s) of the system and method disclosed herein, the in-vehicle application is capable of responding to the in-vehicle user request by generating a Quick Response (QR) code that is retrievable by the mobile communications device. The QR code may encapsulate web URLs for vehicle-specific content or other vehicle-specific content. In these examples, the in-vehicle application recognizes that no mobile communications device is connected to the vehicle, and generates the QR code for retrieval by the mobile communications device.

In each of the examples disclosed herein, the in-vehicle application is capable of determining when to transmit the rich message and/or when to make the QR code available. The in-vehicle application may receive messages from other components of the vehicle which indicate to the application whether the vehicle is in park mode or drive mode. When the vehicle is in drive mode, the application may be programmed to hide content (e.g., not display the QR code) or disable in-vehicle options (e.g., an option to include a URL link in a rich message) that may be undesirable for consumption while the vehicle is in motion.

As an example, if the in-vehicle application determines that the vehicle has experienced a fault that requires attention from a maintenance provider and the vehicle is in drive mode, the in-vehicle application may display a phone call option (or another low cognitive load option, which is described further below) for the user on the in-vehicle display. In this example, the option is to initiate a phone call to the nearest service center using the mobile communications device. If the user selects the phone call option, the in-vehicle application may include in the data package that is transmitted to the mobile communications device, rich message instructions to open the phone number of the nearest service center in the mobile communication device's phone application. Upon receiving the data package, the mobile communication device would launch its phone application and allow the user to place a call.

As another example, if the in-vehicle application determines that the vehicle has experienced a fault that requires attention from a maintenance provider and the vehicle is not in drive mode (is in park mode or is otherwise not in motion), the in-vehicle application may display a phone call option and/or a web page option (or another high cognitive load option, which is described further below) for the user on the in-vehicle display. In this example, one option is to transmit a link to the nearest service center's phone number to the mobile communications device and the other option is to transmit a link for the service center's web page to the mobile communications device. If the user selects one or both options, the in-vehicle application may include in the data package that is transmitted to the mobile communications device, rich message instructions including the phone number link and/or the URL link.

It is to be understood that the application may be programmed to temporarily disable the web page option when the vehicle is determined to be in motion, and then re-enable the web page option when the vehicle comes to a stop.

It is to be understood that, as used herein, the term “user” includes a vehicle owner or another authorized driver of the vehicle, or a mobile communications device owner or another authorized use of the mobile communications device. In some examples, the user is a customer of an in-vehicle infotainment unit service provider that operates the self-reported tracking service.

The term “communication” is to be construed to include all forms of communication, including direct and indirect communication. Indirect communication may include communication between two components with additional component(s) located therebetween.

Further, the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

Still further, the term “vehicle-related information” generally refers to any data, instructions, guidance, cues, etc. received by a vehicle from a server, and/or any data received by vehicle from a vehicle system, where the data, etc. pertains to the vehicle. The term vehicle-related information may also be used to describe a request that is made for data, instructions, guidance, cues, etc. that pertains to the vehicle. The term “vehicle-related action information” generally refers to any data, instructions, guidance, cues, etc. included in the data message that is ultimately sent to a mobile communications device. In some instances, the vehicle-related information and the vehicle-related action information are different (e.g., a low fluid level signal is the vehicle-related information and a reminder to call a maintenance provider is the vehicle-related action information, or a signal indicating that the engine oil life is low is the vehicle-related information and a reminder to visit a maintenance provider is the vehicle-related action information). In other instances, the vehicle-related information and the vehicle-related action information are the same (e.g., a URL for a video about changing a tire is the vehicle-related information received by the server and is also the vehicle-related action information included in the data message).

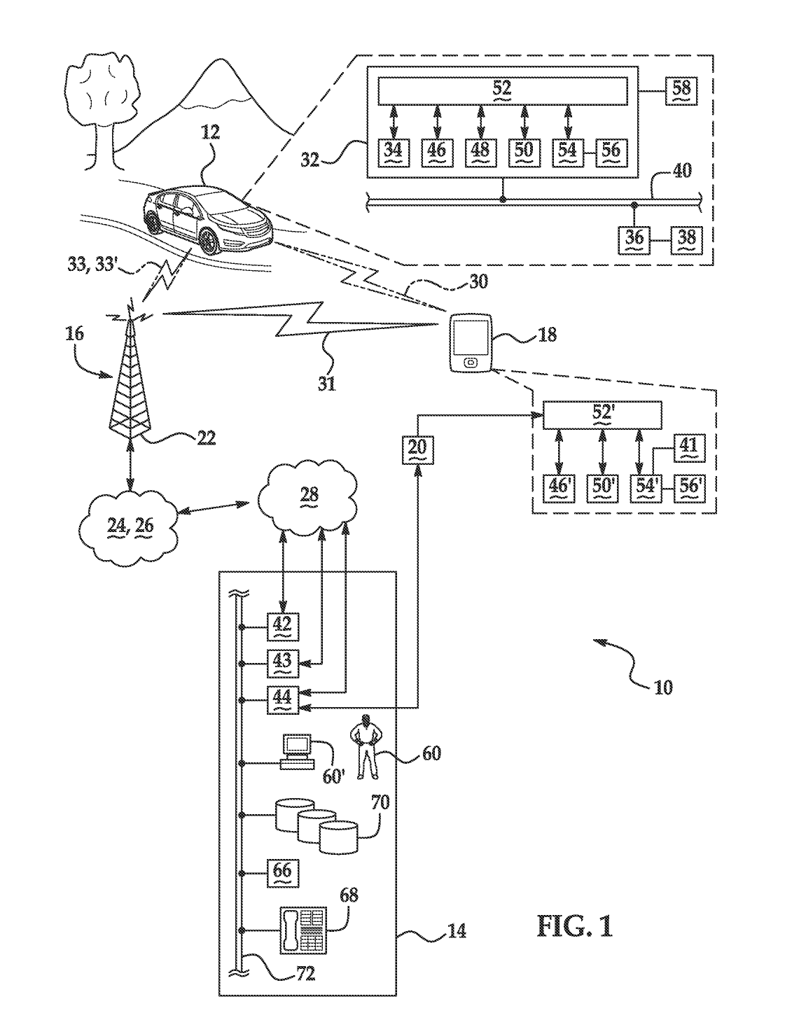

Referring now to FIG. 1, an example of a system 10 for performing examples of the vehicle-related information sharing method disclosed herein is depicted. In the examples of the method involving the transmission of rich message(s), the system 10 includes a vehicle 12, a vehicle communications platform (VCP) service provider 14, a carrier/communication system 16, a mobile communications device 18, and a proprietary messaging server 20. In other examples of the method involving the generation and retrieval of QR codes, the system 10 includes the vehicle 12, the vehicle communications platform (VCP) service provider 14, the carrier/communication system 16, and the mobile communications device 18.

In some of the examples disclosed herein, the rich message(s) may be transmitted from communication component(s) of the vehicle 12 to a messaging server 44 of the VCP service provider 14, from the messaging server 44 to the proprietary messaging server 20, and then from the proprietary messaging server 20 to the mobile communications device 18. The operating system of the mobile communications device 18 wakes an application on the mobile communications device in order to deliver the rich message to the application. An Internet connection is utilized for the transmission of the rich message(s). The transmission of the rich messages may be made using the carrier/communication system 16, either through the vehicle's Internet connection 33 (e.g., when the vehicle 12 is equipped with a 4G long-term evolution, LTE, or other suitable Internet connection) or through the mobile communications device's cellular and Internet connection 31. When the mobile communications device's cellular Internet connection 31 is utilized, it is to be understood that vehicle 12 is connected to the cellular and Internet connection 31 through a short range wireless communication link 30 with the mobile communications device 18.

The carrier/communication system 16 may include one or more cell towers 22 or satellites (not shown). It is to be understood that the carrier/communication system 16 may also include one or more base stations and/or mobile switching centers (MSCs) 24 (e.g., for a 2G/3G network), one or more evolved Node Bs (eNodeB) and evolved packet cores (EPC) 26 (for a 4G (LTE) network), and/or one or more land networks 28. The carrier/communication system 16 may be part of a cellular radio environment or a satellite radio environment, which may include a variety of wireless network providers (which include mobile network operator(s), not shown), utilizing the same or a variety of radio access technologies. While several examples have been provided, it is to be understood that the architecture of the carrier/communication system 16 may be GSM (global system for mobile telecommunications), CDMA2000, UMTS (universal mobile telecommunications system), LTE (long-term evolution), or some other available architecture.

While the Internet connection(s) 31, 33 may be used for the transmission of the rich message(s), it is to be understood that the carrier/communication system 16 may also enable cellular connections 31, 33′ to be made between communication component(s) of the vehicle 12, communication component(s) of the VCP service provider 14, and/or the mobile communications device 18.

The various connections/communication links between the various components are shown as lightning bolts in FIG. 1. Some of the connections/communications links (e.g., between the vehicle 12 and the cell tower 22, and between the vehicle 12 and the mobile communications device 18) are shown in phantom. This is indicative of the fact that these components may not always be able to establish a connection/communication link with one another. For example, some of the examples disclosed herein involve a situation where the vehicle 12 is equipped to establish a cellular connection 33′ but not an Internet connection 33, or where the mobile communications device 18 is turned off or is otherwise not within range of the vehicle 12 to establish the short range wireless communication link 30.

The vehicle 12 may be a car, motorcycle, truck, or recreational vehicle (RV) that is equipped with suitable hardware and computer readable instructions/code that enable it to communicate (e.g., transmit and/or receive voice and data communications) over the carrier/communication system 16 and/or using a short range wireless communication link 30.

As shown in FIG. 1, the vehicle 12 includes a vehicle communications platform (VCP, also referred to herein as a communications platform) 32. In one example, the VCP 32 is an on-board vehicle dedicated communications and entertainment device. In another example (not shown), the VCP 32 is an on-board vehicle dedicated communications device (e.g., a telematics unit) that is in operative communication with a separate on-board vehicle dedicated entertainment device. Whether integrated into a single unit or included as separate units, the on-board vehicle dedicated communications and entertainment device(s) include hardware components that are capable of running computer readable instructions/code, which are embodied on non-transitory, tangible computer readable media.

The VCP 32 may be used for vehicle communications. In some instances, vehicle communications are enabled through the VCP 32 via a communications module, which includes a cellular chipset/component 46 for voice communications and a data transmission system 48 for data (e.g., rich message or data package) transmission. The data transmission system 48 may include any hardware component(s) and software that equip the vehicle 12 with an Internet connection, such as a 4G LTE connection. In another example, the data transmission system 48 may include a wireless modem, which applies some type of encoding or modulation to convert the digital data so that it can communicate through a vocoder or speech codec incorporated in the cellular chipset/component 46. It is to be understood that any suitable encoding or modulation technique that provides an acceptable data rate and bit error may be used with the examples disclosed herein. While examples have been provided, it is to be understood that any suitable data transmission system 48 may be used.

The cellular chipset/component 46 of the VCP 32 may be an analog, digital, dual-mode, dual-band, multi-mode and/or multi-band wireless transceiver. The cellular chipset-component 46 uses one or more prescribed frequencies in standard analog and/or digital bands in the current market for cellular systems. Any suitable protocol may be used, including digital transmission technologies, such as TDMA (time division multiple access), CDMA (code division multiple access), W-CDMA (wideband CDMA), FDMA (frequency-division multiple access), OFDMA (orthogonal frequency-division multiple access), etc.

The VCP 32 may also be configured for short range wireless communication technologies, such as BLUETOOTH® and various classes thereof, dedicated short-range communications (DSRC), or WI-FI™ and various classes thereof (e.g., WI-FI™ direct). In these instances, the cellular chipset/component 46 may operate in conjunction with a short range wireless communication unit 50 of the VCP 32. As mentioned above, short range wireless communications may be suitable for communication between, for example, the vehicle 12 and the mobile communications device 18. The use of short-range wireless communication technologies will depend, at least in part, on the distance of the short range wireless communication unit 50 from the mobile communications device 18. For example, when the short range wireless communication unit 50 is configured for some BLUETOOTH® connections, the short-range wireless communication unit 50 may have a preset wireless access range, or may have a standard range from about 10 meters (i.e., about 32 feet) to about 91 meters (i.e., about 300 feet).

The VCP 32 generally includes an electronic processing device 52 operatively coupled to one or more types of electronic memory 54, which has the in-vehicle application 56 resident thereon. In an example, the electronic processing device 52 is a micro-processor. In other examples, the electronic processing device 52 may be a micro controller, a controller, a host processor, and/or a vehicle communications processor. In another example, electronic processing device 52 may be an application specific integrated circuit (ASIC). Alternatively, electronic processing device 52 may be a processor working in conjunction with a central processing unit (CPU) performing the function of a general-purpose processor.

The electronic memory 54 of the VCP 32 may be an encrypted memory that is configured to store i) computer readable instructions/code to be executed by the processor 52, ii) data associated with the various systems of the vehicle 12 (i.e., vehicle data), iii) vehicle operations, iv) vehicle user preferences and/or personal information, and the like. In an example, the electronic memory 54 stores the computer readable instructions of the in-vehicle application 56. The electronic memory 54 may also store a unique identifying code that can be used to establish the short range wireless communication link 30 with the mobile communications device 18.

In some examples, the in-vehicle application 56 may be downloaded (e.g., from an online application store or marketplace through the vehicle's Internet connection 33 or the connected mobile device's cellular and Internet connection 31) and stored on the electronic memory 54. The application 56 may be opened using an in-vehicle display 58. The display 58 may be operatively directly connected to or in communication with the VCP 32. Examples of the display 58 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like. In an example, the display 58 is a full-color touch screen display. In some instances, the application 56 may be opened by a user via an icon on the display 58, or the application 56 may open automatically upon receipt of vehicle-related information.

In some examples, the application 56 enables the user to input his/her request for vehicle-related information. As such, the in-vehicle application 56 includes computer readable instructions for receiving vehicle-related information requests from an in-vehicle user. The vehicle-related information that is the subject of the user request may be any information pertaining to the care and/or maintenance of the vehicle 12, the use of the vehicle 12, or any other vehicle specific information. As examples, information pertaining to the care and/or maintenance of the vehicle 12 may include information about how to change a tire, information about how to change an exterior or interior bulb, information about how to fill and/or drain vehicle fluid(s), information about the type of vehicle fluid(s) to use, information about system parameters (e.g., tire pressure, tire pressure for current exterior temperatures, fuel tank capacity, etc.), information about the nearest vehicle maintenance service provider, information about how to wax the car, care for the interior, etc., information about how and/or when to change the oil, information about vehicle error codes, or the like. As other examples, information pertaining to the use of the vehicle 12 may include information about the maximum speed the vehicle 12 can go based on current vehicle and load weight, how to preset radio stations, information about how to sign up for satellite radio and/or VCP service provider services, information about the use of the instrument panel, or the like.

The in-vehicle application 56 may have URLs to various vehicle-related videos hard coded therein. In these instances, the in-vehicle application 56 can retrieve an appropriate URL in response to the user request.

The in-vehicle application 56 may also include computer readable instructions for transmitting the request for vehicle-related information to a source outside the vehicle 12. In an example, the source outside the vehicle 12 is a third party web service (not shown) that is in communication with the in-vehicle application 56. The third party web service may be set up to receive the request (which may include the vehicle identification number (VIN)), decode the VIN, and use the VIN and other details of the request to determine which vehicle related information to transmit back to the application 56.

In another example, the source outside the vehicle 12 is a content server 43 at the VCP service provider 14. This content server 43 may be a dedicated server that receives and responds to the vehicle-related information requests from the application 56. The content server 43 is a system of computer hardware and computer readable instructions that is capable of responding to requests from the vehicle 12. For example, the server 43 may be able identify the application 56 and the vehicle 12 through an authentication token (e.g., an alphanumeric string) that is transmitted in a header of the request. The authentication token is associated with the user's and/or vehicle's account with the VCP service provider 14, which is available to the application 56 through the vehicle's application programming interface (API). Upon identifying the vehicle 12, the content server 43 can automatically look up any vehicle-related information that may be saved in database(s) 70 of the VCP service provider 14 or available to the server 43 from another information source.

In some examples, the in-vehicle application may not have access to vehicle data points. When the in-vehicle application 56 does not have access to vehicle data points, the application 56 may request such information from the content server 43. In this example, the in-vehicle application 56 would send a request for a complete vehicle read, or specific data points, to the content server 43. The content server 43 returns the vehicle information back to the in-vehicle application 56. It is to be understood that any vehicle data stored at the VCP service center 14 is uploaded by the vehicle system(s) (other than the in-vehicle application 56), for example, at the start and end of a drive, when certain events take place in the vehicle 12, or when the content server 43 sends an information request to the vehicle system.

In other examples, the in-vehicle application 56 may have access to vehicle data points. In these instances, the in-vehicle application 56 may collect the data point that is responsive to the request, and may respond to the user request without transmitting the request outside of the vehicle 12. The in-vehicle application 56 may not have direct access to the vehicle data points. In these instances, the application 56 may obtain vehicle data points using vehicle specific application programming interface (API) calls that are local to an infotainment application layer (which is part of the VCP 32). In response to the API call, the infotainment application layer may return the requested data points or information in the form of a Javascript Object Notation (JSON) object. As one example, in response to an API call to the infotainment application layer, the application 56 may receive an indication/notification (through a vehicle bus 40 and an associated sensor interface 36) that a vehicle issue or potential vehicle issue (e.g., flat tire, low fluid, etc.) has been sensed by one of the vehicle sensors 38. As another example, the application 56 may receive an indication/notification from the processor 52 that a maintenance milestone for the vehicle 12 is approaching.

Upon receiving the vehicle-related information, the application 56 may be programmed to prompt the user to initiate a request for additional vehicle-related information. For example, if the application 56 receives a notification in response to an API call that a tire is flat, the application 56 may provide the user with the option to initiate a request for instructions on how to change a tire for their specific make and type of vehicle. If the user would like to receive this information (ultimately at his/her mobile device 18), he/she may initiate the request through an icon or button click that the application 56 is programmed to recognize. In response to a positive user input, the application 56 may retrieve a suitable URL, or transmit the request to the third party web server or the content server 43.

Upon receiving the vehicle-related information, the application 56 may also identify information and/or an action to be included in the rich message, without initiating a request for additional vehicle-related information. For example, if the application 56 receives a notification that the vehicle 12 is approaching a maintenance milestone (e.g., is due for an oil change), the application 56 may determine that vehicle information (e.g., mileage and vehicle identification number (VIN) stored in the memory 54) and an action reminder to call the maintenance provider can be sent to the mobile communications device.

The in-vehicle application 56 is capable of receiving the vehicle related information from the third party web service, the content server 43 and/or from the other vehicle systems, and in response, determining what mobile communications device 18 the rich message/data package is to be transmitted to. In determining what mobile communications device 18 to send message(s) to, the application 56 also recognizes that the mobile communications device 18 has a vehicle-related application 56′ (e.g., RemoteLink™ by OnStar) resident on a memory 54′ and that a rich-messaging feature of the vehicle-related application 56′ is enabled.

The in-vehicle application 56 can identify the mobile communications device 18 by recognizing that the mobile communications device 18 is connected to the VCP 32 through the short range wireless connection link 30 (e.g., Wi-Fi Direct). Upon recognizing the connected device 18, the application 56 is capable of issuing a command to the mobile communication device 18 to identity the device's operating system. Once the mobile communication device 18 returns its operating system, the vehicle 12 issues another command to launch the vehicle-related application 56′. If the vehicle-related application 56′ returns a success response, the application 56 recognizes that the mobile communications device 18 has the vehicle-related application 56′.

The in-vehicle application 56 then issues yet another command requesting the vehicle-related application 56′ to return a vehicle-related application identifier for the device's proprietary messaging service. The vehicle-related application identifier may be a registration id which is unique to the device 18 and the application 56′ or a device token which is unique to the device 18. The vehicle-related application identifier will be described in more detail below. Once the unique identifier has been returned to the application 56, the application 56 recognizes that the vehicle-related application 56′ has its rich message feature enabled. The application 56 can temporarily retain, in the memory 54, the vehicle-related application identifier until the vehicle 12 is turned off. In some examples, the identifier enables the application 56 with the rich messaging feature of the mobile communications device 18. In other words, in this example, the application 56 can utilize the identifier to transmit rich messages to the mobile communications device 18.

The in-vehicle application 56 can also identify the mobile communications device 18 by recognizing that no mobile communications device 18 is connected to the VCP 32, and by transmitting a request to the content server 43. This request asks for a list of mobile communications devices 18 that have been registered with the user's and/or vehicle's account with the VCP service provider 14. This list may be stored in a user profile at the VCP service provider 14. The request may include the authentication token of the user's and/or vehicle's account with the VCP service provider 14, which is available to the application 56 through the vehicle's application programming interface (API). This authentication token identifies the user and/or vehicle account for the server 43.

The server 43 receives the request, and from the identified user profile, retrieves the list of registered mobile communications device(s) 18. In particular, the server 43 retrieves those registered devices 18 that have the vehicle-related application 56′ installed thereon and have the rich message feature enabled. The application 56 receives this list, and displays the list on display 58 for the in-vehicle user to select which mobile communications device 18 to have message(s) transmitted to. The application 56 receives the user's selection through an input on the display 58 and/or through a button press.

In the example where the application 56 identifies the mobile communications device 18 using the content server 43 and user input, the application 56 utilizes the mobile device phone number and its own Internet connection to initiate the transmission of rich messages to the mobile communications device 18.

The application 56 is also programmed to generate or prepare the rich message/data package for the identified mobile communications device 18 based on the received vehicle-related information. The application 56 may include a packet builder, which is programmed to make decisions about what packet to send (e.g., bandwidth, data to include, etc.) and to actually build rich messages/data packages

The payload of the rich message/data package includes vehicle-related action information. The vehicle-related action information may include a reminder, action item, or cue for the user (e.g., schedule an oil change), instructions for the user (e.g., a link to a video for how to change a tire, attach a trailer hitch, etc.), or other vehicle specific content for the user (e.g., vehicle information to provide to a maintenance person, details about the infotainment center and its capabilities, etc.). The vehicle-related action information may be based upon the vehicle-related information retrieved by the application 56, received from the content server 43 or other outside source, and/or received from the vehicle system. For example, when the received vehicle-related information is that the vehicle 12 is low on windshield wiper fluid, the vehicle-related action information may be a reminder to fill the fluid, or information about the type of fluid that is to be used, etc. In some instances, the vehicle-related action information is the vehicle-related information received from the content server 43 or other outside information source. For example, when the user requests information about how to fill the windshield wiper fluid, the received vehicle-related information (from the content server 43 or third party web service) and the vehicle-related action information included in the message may be a link to a video explaining how the fill the fluid for the user's specific vehicle 12.

This vehicle-related action information in the rich message/data package may be in the form of a short message, a web URL for vehicle-specific content, and/or a mobile device command. The mobile device command starts a mobile device service (e.g., launches a calling application) or provides the user with an option to start a mobile device service, such as placing a phone call (e.g., by providing a link with a phone number), launching a web URL, or saving a reminder to the mobile communications device 18. Based upon the vehicle-related information that is received, the application 56 will determine the vehicle-related action information to include in the rich message, and the form in which to include the vehicle-related action information.

When determining the form in which the vehicle-related action information will be included, the application 56 may be programmed to look at the current state of the vehicle 12. In particular, the application 56 may determine whether the vehicle 12 is in drive mode or park mode. This determination may be made using signals received from other vehicle systems. Depending upon the state of the vehicle 12, the application 56 is programmed to provide one or more options to the user on the in-vehicle display 58. These options may be high cognitive load options or low cognitive load options. High cognitive load options may be any task that requires more thought from the driver to complete, such as picking up the mobile communications device 18 to view/navigate a website (e.g., web page option) or entering user information into a service request. High cognitive load options may be presented when the vehicle is in park mode. Low cognitive load options may be any task that requires little thought from the driver to complete, such as placing a phone call using the mobile communications device 18 (phone call option), sending a reminder or appointment to the mobile communications device 18, pushing a location of nearest repair shop to the in-vehicle navigation system, or switching on a vehicle system. An example of switching on a vehicle system would include the application 56 notifying the user that the vehicle engine is about to overheat, and then giving the option to switch on the heat.

When the application 56 recognizes that the vehicle 12 is in drive mode, the application 56 may provide the user with any appropriate low cognitive load option (e.g., the phone call option and the appointment option) and may also disable any high cognitive load options (e.g., the web page option). In this example, if the user selects the phone call option and the appointment option, two rich messages may be sent out by the in-vehicle application 56. Both rich messages would provide instructions for the application 56′ to start a process on the mobile communication device 18, one to bring up the service center's phone number in the phone's dialer application and the other to display a modal asking the user if he/she would like to save the service center appointment to their mobile communications device's calendar. When the application 56 recognizes that the vehicle 12 is not in drive mode, the application 56 may provide the user with any appropriate low cognitive load option (e.g., the phone call option, the appointment option, etc.) and any appropriate high cognitive load option (e.g., the web page option). In this example, if the user selects one or more of the options, the rich message(s) sent out by the in-vehicle application 56 would provide instructions for the application 56′ to start the process on the mobile communication device 18 (e.g., launch dialer application and pre-populate with phone number, or save an appointment, or launch web browser and point it towards the provided URL).

The application 56 may also prepare and transmit updated messages upon recognizing that the vehicle 12 has transmission from drive mode to park mode. For example, if the vehicle-related information includes the URL for vehicle specific content, and the application 56 recognizes that the vehicle 12 has transitioned from drive mode to park mode; the application 56 may display any appropriate high cognitive load option (e.g., the web page option) for the in-vehicle user. In this example, if the user selects the option, the application 56 will generate the rich message with packaged instructions that instruct the mobile communications device 18 to launch the web URL.

The payload of the rich message/data package prepared by the application 56 also includes the mobile communications device phone number. The phone number may have come from the connected device 18 or from the list sent from the content server 43. The phone number identifies the device 18 that the message is to be sent to and may be used by the messaging server 44 of the VCP service center 14 and the proprietary messaging server 20 to transmit the message to the correct mobile device 18.

When the message is prepared, the application 56 may be programmed to automatically initiate the transmission of the message to the mobile communications device 18, or it may be programmed to prompt the user to initiate the transmission of the data message to his/her mobile communications device 18. When programmed to prompt the user, the application 56 will display a message asking the user if he/she wants the message to be sent, and if the user would like to receive this information at his/her mobile device 18, he/she may initiate the transmission through an icon or button click that the application 56 is programmed to recognize.

The application 56 may also be programmed to prompt the user to initiate the transmission of other data messages to a third party. As an example, if the application 56 receives a notification that a vehicle component (e.g., transmission) needs servicing, the application 56 may provide the user with multiple options after identifying the mobile communications device 18 and generating the rich message. In this example, one option may include sending a dealership service center (e.g., that is nearest to the vehicle's then-current location) information about the vehicle 12, including mileage and VIN. The application 56 may receive dealership information from the content server 43 or may retrieve dealership information from the on-board memory 54. In this example, another option may include sending the mobile device 18 the contact information for the dealership service center, alone or in combination with an action reminder to call the dealership service center. If the user would like to initiate either or both of the options, he/she may approve through an icon or button click that the application 56 is programmed to recognize.

In still other examples, the application 56 is capable of generating a QR code. When the vehicle-related information received by the application 56 is a web URL and the mobile communications device 18 is not connected to the VCP 32, the application 56 may generate the QR code, which encapsulates the web URL.

After generating the QR code, the application 56 may make a determination as to whether the vehicle 12 is in park mode or drive mode. When the application 56 recognizes that the vehicle 12 is in park mode, the application 56 is programmed to display the QR code on the display 58 for retrieval by the mobile communications device 18. When the application 56 recognizes that the vehicle 12 is in drive mode, the application 56 is programmed to generate a message indicating that the QR code has been generated, and to display the message on the display 58. This message apprises the in-vehicle user that vehicle-related information will be available through the QR code. In these instances, the QR code is temporarily stored in the memory 54. Upon recognizing that the vehicle 12 is no longer in drive mode, the application 56 is capable of retrieving the QR code from the memory 54 and displaying the QR code on the display 58 for retrieval by the mobile communications device 18.

As shown in FIG. 1, the VCP 32 may also include other components, such as a location detection chipset/component 34, which may include a GPS receiver, a radio triangulation system, a dead reckoning position system, and/or combinations thereof. In particular, a GPS receiver provides accurate time and latitude and longitude coordinates of the vehicle 12 responsive to a GPS broadcast signal received from a GPS satellite constellation (not shown). The location detection chipset/component 34 may also include, for example, Glonass (i.e., global navigation satellite system), Sbas (i.e., satellite-based augmentation systems), or a D-GPS (differential global positioning system). The location detection chipset/component 34 may or may not be part of an in-vehicle navigation unit.

While not shown, it is to be understood that the VCP 32 may also include a real-time clock (RTC), a short-range wireless antenna, and/or a multi-band or multi-mode antenna. The real-time clock (RTC) provides accurate date and time information to the VCP 32 hardware and software components that may require and/or request date and time information. The short-range wireless antenna may service the short-range wireless communication unit 50 and the multi-band or multi-mode antenna may service the location detection chipset/component 34 and the cellular chipset/component 46. The multi-band or multi-mode antenna may, however, handle a variety of services, such as cellular, location (e.g., GPS), radio, short range (e.g., WI-FI™). In other instances, separate antennas are used for each service, or separate antennas are used for certain combinations of services. It is to be understood that the VCP 32 may be implemented without one or more of the above listed components, or may include additional components and functionality as desired for a particular end use.

The VCP 32 is also operatively connected to a vehicle bus system 40. The vehicle bus system 40 may utilize a variety of networking protocols, such as a controller area network (CAN), a media oriented system transfer (MOST), a local interconnection network (LIN), an Ethernet, TCP/IP, and other appropriate connections such as those that conform with known ISO, SAE, and IEEE standards and specifications, to name a few. The vehicle bus system 40 enables the vehicle 12 to send signals (e.g., real-time bus messages, rich message(s)) from the VCP 32 (and application 56 resident on the memory 54) to various units of equipment and systems both outside the vehicle 12 and within the vehicle 12. The vehicle bus system 40 also enables the vehicle 12 to receive signals at the VCP 32 from various units of equipment and systems both outside the vehicle 12 and within the vehicle 12 (e.g., from sensors 38).

The VCP 32 may also include an audio component that receives analog information, rendering it as sound, via an audio bus system (not shown). Digital information may be received at the VCP 32 via the vehicle bus system 40. The audio component may provide AM and FM radio, high-definition radio, satellite radio, CD, DVD, multimedia, and other like functionality, in conjunction with the controller/processor 52 of the VCP 32. The VCP 32 may contain a speaker system, or may utilize vehicle speaker(s) (not shown) via arbitration on vehicle bus system 40 and/or audio bus system.

As illustrated in FIG. 1, the vehicle 12 may also include other vehicle systems that are connected to the vehicle bus system 40. Examples of these other vehicle systems may include any vehicle sensors 38 (e.g., tire pressure sensors, crash/collision sensors, electronic system power sensors, door lock and unlock sensors, etc.). The sensors 38 provide information to the VCP 32 via a sensor interface module 36. Examples of the sensor interface modules 36 include a powertrain control module, a climate control module, a body control module, and/or the like.

As mentioned above, the system 10 also includes the mobile communications device 18 that ultimately receives the rich message(s) from the application 56 or retrieves the QR code generated by the application 56. In an example, the mobile communications device 18 may be a smart phone, such as a GSM/LTE phone or a GSM/CDMA/LTE phone. In other examples, the mobile communications device 18 may be any portable device that has at least a cellular chipset/component 46′ (e.g., for making an Internet connection) and a short range wireless communication unit 50′. Examples of other mobile communications devices 18 include a tablet computer or a wearable device. Some wearable devices may require a phone to provide the internet connection, but rich messages can be pushed to them. In an example, after the driver has parked his/her vehicle 12, directions to their destination could be pushed from the vehicle application 56 to a wearable device that includes an application similar to application 56′.

It is to be understood that the mobile communications device 18 has a unique identifying code (e.g., a wireless connection key) that is used to pair the device 18 with the VCP 32 of the vehicle 12 (e.g., over short range wireless communication link 30). The mobile communications device 18 and the VCP 32 are paired when the device 18 and VCP 32 exchange unique identifying codes with each other. This enables the device 18 and VCP 32 to communicate typically under a secured connection. As a more specific example, initial pairing may involve setting the mobile communications device 18 to a short range wireless discovery mode (such as by selecting, on the device 18, a discovery mode function as a menu option, icon, or the like). While in the discovery mode, other devices having a short range wireless communication unit (such as the VCP 32) are allowed to detect the presence of the mobile communications device 18. When the VCP 32 locates the mobile communications device 18, the mobile communications device 18 automatically provides the type of device it is (e.g., a smart phone, etc.) and its short range wireless connection name. The mobile communications device 18 may then prompt the user to enter a security code/password, and then the unique identifying code of the mobile communications device 18 is sent to the VCP 32. Upon receiving the unique identifying code, the VCP 32 sends its own unique identifying code to the mobile communications device 18 to ultimately pair the two devices 18, 32 together.

Once the device 18 and unit 32 have been paired and whenever within short range wireless communication range of each other, the mobile communications device 18 can directly communicate with the VCP 32.

The mobile communications device 18 may also include physical hardware (e.g., a micro-processor 52′) and computer readable instructions stored in a memory 54′. The micro-processor 52′ of the mobile communications device 18 may be similar to processor 52, and is capable of executing the computer readable instructions stored in the memory 54′. At least some of the computer readable instructions include the device's operating system.

The operating system of the mobile communications device 18 is capable of receiving the rich message(s). From the vehicle-related application identifier included in the payload of the message, the operating system can identify the application on the device 18 that is to receive the message. If the application is not then-currently running, the operating system can wake up the application to receive and unpack the message.

As shown in FIG. 1, the mobile communications device 18 has the vehicle-related application 56′ resident on its memory 54′. The vehicle-related application 56′ may be able to create a secure connection between the mobile communications device 18 and the vehicle 12, so that the mobile communications device 18 can receive and display vehicle information. In the examples disclosed herein, the vehicle-related application 56′ handles displaying content received in the rich message or issuing mobile device commands, such as saving a reminder to the device 18, launching a web URL, or placing a phone call.

The vehicle-related application 56′ may be downloaded (e.g., from an online application store or marketplace) and stored on the electronic memory 54′. When the vehicle-related application 56′ is installed on the user's mobile device 18, the user is presented with option to turn on a proprietary messaging service (e.g., Apple's Push Notification (PN) service or Google's Cloud Messaging (GCM) service). Acceptance will enable the remote or rich message feature. If the user accepts, the vehicle-related application 56′ registers with the proprietary messaging server 20 of the proprietary messaging service of the mobile device 18.

When the vehicle-related application 56′ registers with the mobile communications device's proprietary messaging service, an alphanumeric string is passed to the vehicle-related application 56′. This alphanumeric string is the vehicle-related application identifier. One example of this alphanumeric string is a registration ID and another example of this alphanumeric string is a device token. The registration ID is unique to the mobile communications device 18 and to the vehicle-related application 56′, and may be used by the proprietary messaging server 20 to determine which mobile communications device 18 and vehicle-related application 56′ to pass the rich message(s) to. The device token is unique to the mobile communications device 18, and may be used by the proprietary messaging server 20 to determine which mobile communications device 18 to pass rich message(s) to. When the device token is used, the proprietary messaging server 20 identifies the vehicle-related application 56′ using a recorded URL or other authentication token of the messaging server 44 (which is pre-registered with the proprietary messaging server 20 and thus is acknowledged as a trusted server). The recorded URL allows the proprietary messaging server 20 to know that any messages from the messaging server 44 are connected to the vehicle-related application 56′.

When registering the vehicle-related application 56′ with the proprietary messaging server 20, the vehicle-related application 56′ also sends a request to the messaging server 44 of the VCP service provider 14 to register with the messaging server 44. The payload of this request includes the mobile device's phone number, the vehicle-related application identifier, and the mobile device's operating system. This information is added to the database 70 and is linked with the user's account. The messaging server 44 can access this information for subsequent use.

The mobile communications device 18 may also include a quick response (QR) reader application 41, which is capable of decoding QR codes and URLs contained therein, and launching the URLs within a web browser on the mobile communications device 18.

The system 10 also includes the VCP service provider 14. In the examples disclosed herein, the user is a customer of the VCP service provider 14. The VCP service provider 14 is capable of communicating with the VCP 32 when the vehicle 12 is within the coverage area of the carrier/communication system 16, and/or when the vehicle is connected to the mobile communications device 18 which is within the coverage area of the carrier/communication system 16.

The VCP service provider 14 includes the content server 43 and the messaging server 44, each of which is a system of computer hardware and computer readable instructions. The content server 43 responds to requests from the in-vehicle application 56. The server 43 may include computer readable instructions that enable the server 43 to recognize the vehicle 12 from which a request is being received (through the authentication token that is transmitted in a header of the request). The server 43 may also include computer readable instructions that use the identified vehicle 12 and any information in the request to automatically look up the vehicle specific content that is responsive to the request. For example, if the request is for information on how to change the tire of a 2014 Chevrolet Camaro, the server 43 may retrieve a video, a URL to a video, or text instructions that is stored in the database 70. For example, the server 43 may use the query tire and 2014 Chevrolet Camaro to search the database 70. The server 43 is also programmed to initiate the transmission of any retrieved vehicle-related information back to the requesting application 56.

The messaging server 44 is a trusted application server that can communicate with the proprietary messaging server 20. In some examples disclosed herein, the application 56 transmits the rich message(s) from the vehicle 12 to the server 44. When the rich message includes the mobile device phone number, the server 44 is programmed to retrieve the vehicle-related application identifier (which was stored during application 56′ registration) using the mobile device phone number and the user's account. In this example, the server 44 then replaces the mobile device phone number with the retrieved vehicle-related application identifier and may add the proprietary messaging service authentication token in the payload of the rich message, and sends the rich message on to the proprietary messaging server 20. The messaging server's authentication token may be an API key or a security certification, such as a provisioning profile, that is generated when the messaging server 44 registers with the proprietary messaging service.

In some examples, the rich message transmitted by the messaging server 44 contains the vehicle-related action information that is transmitted in the original message from the application 56. In these examples then, the content of the rich message is sent from the application 56 to the application 56′. In other examples, the messaging server 44 may supplement the rich message received by the application 56 with additional vehicle-related action information. For example, the messaging server 44 may analyze the content of the rich message and may query the content server 43 for additional information to include in the rich message. In these examples, the content of the rich message that is ultimately sent to the mobile communications device 18 is from the application 56 and from the VCP service provider 14. In these examples, the rich message that is ultimately transmitted to the mobile communications device 18 has content and a context that is determined by the rich message the server 44 originally receives from the application 56. For example, if the original rich message received by the server 44 includes a URL that is stored in the application 56, the server 44 may add to the message additional information that is stored in the content server 43.

In addition to the servers 43 and 44, the VCP service provider 14 may also include switch(es) 42, advisors 60, 60′, database(s) 70, processor(s) 66, and other telecommunication and computer equipment 68. The various operations of the VCP service provider 14 may be carried out by one or more computers (e.g., computer equipment 68) programmed to carry out such tasks. The telecommunication and computer equipment 68 (including computers) may include a network of servers (including server 44) coupled to both locally stored and remote databases (e.g., database 70) of any information processed.

The database(s) 70 may be designed to store vehicle record(s), subscriber/user profile or account records (including a list of mobile communications devices 18 associated with the vehicle 12), or any other pertinent subscriber and/or vehicle information and/or mobile communications device information. The database(s) 70 may also be designed to store a variety of vehicle-related information (i.e., vehicle specific content). It is to be understood that the databases 70 may allow the call center 14 to function as a repository for data collected from the vehicle 12, data collected from the vehicle owner/driver, and data that may be useful for the vehicle owner/driver.

The switch 42 may be a private branch exchange (PBX) switch. The switch routes incoming signals so that voice transmissions are usually sent to either a live advisor 60 or an automated response system 60′, and data transmissions are passed on to a modem or other piece of equipment for demodulation and further signal processing. The modem preferably includes an encoder, as previously explained, and can be connected to various devices such as the server 44 and database 70.

As illustrated in FIG. 1, the various call center components are coupled to one another via a network connection or bus 72, such as one similar to the vehicle bus 40 previously described.

It is to be appreciated that the VCP service provider 14 may be any central or remote facility, manned or unmanned, mobile or fixed, to or from which it is desirable to exchange voice and data communications. As such, the live advisor 60 may be physically present at the VCP service provider 14 or may be located remote from the VCP service provider 14 while communicating therethrough.

The VCP service provider 14 shown in FIG. 1 may also be virtualized and configured in a Cloud Computer, that is, in an Internet-based computing environment. For example, the computer equipment 68 may be accessed as a Cloud platform service, or PaaS (Platform as a Service), utilizing Cloud infrastructure rather than hosting computer equipment 68 at the call center 14. The database 70 and server 44 may also be virtualized as a Cloud resource. The Cloud infrastructure, known as IaaS (Infrastructure as a Service), typically utilizes a platform virtualization environment as a service, which may include components such as the processor 66, database 70, server 44 and computer equipment 68. In an example, messaging service disclosed herein may be performed, at least partially, in the Cloud via the SaaS (Software as a Service). For example, requests may be acted upon, and message(s) may be transmitted by the server 44, which may be configured as a service present in the Cloud.

As mentioned above, the system 10 also includes the proprietary messaging server 20. This server 20 is part of the proprietary messaging service of the mobile communications device 18. The server 20 authenticates that rich message(s) is/are received from a trusted source (e.g., messaging server 44), and then sends the rich message(s) on to the appropriate mobile communications device 18.

As briefly mentioned above, the proprietary messaging service provides the server 44 with a unique authentication token or a security certification, such as a provisioning profile, when the server 44 submits a registration request. Once the authentication token is provided, the server 44 uses the authentication token whenever transmitting messages to the server 20. The authentication token verifies that the sender (in these examples server 44) is a trusted source of the proprietary messaging service and also authenticates the messages sent from the server 44.

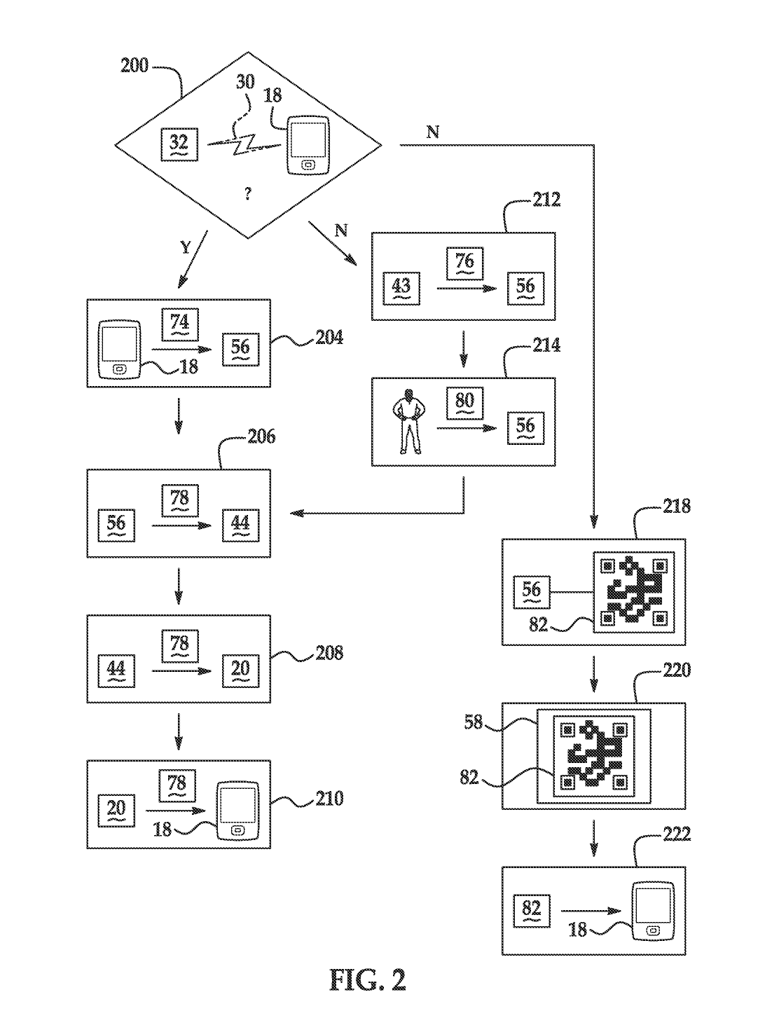

The system 10 shown in FIG. 1 enables the vehicle 12 to provide vehicle-related information to the user's mobile device 18 through rich message(s) or QR codes. Different examples of the method are shown in FIG. 2. It is to be understood that various components of the system 10 of FIG. 1 may be referenced throughout the discussion of FIG. 2, but may not be shown in FIG. 2.

While not shown in FIG. 2, it is to be understood that the methods begin with either a user requesting vehicle-related information through the in-vehicle application 56, or the application 56 determining that it may be desirable to transmit vehicle-related action information to the user (e.g., a notification of a flat tire, notification of a maintenance milestone, notification of an error code in response to an API call, etc.).

In this example, the user has requested information on how to change a flat tire for her specific vehicle 12. The user inputs the request using the application 56 and the display 58, and the application 56 retrieves the information or transmits the request to the content server 43 or to a third party web service. The content server 43 or third party web service retrieves a web URL with a video showing how to change the tire, along with the phone number of a nearby tire service center. The content server 43 or third party web service transmits this vehicle-related information back to the application 56.

As shown in FIG. 2 at box 200, each of the examples of the method then includes the application 56 determining whether the mobile communications device 18 is connected to the VCP 32.

When the mobile communications device 18 is connected to the VCP 32, the VCP 32 may determine whether the mobile communications device 18 includes the vehicle-related application 56′ and has rich messaging enabled. This may be accomplished by the application 56 issuing a command to the mobile communication device 18 to identity the device's operating system. Once the mobile communication device 18 returns its operating system, the vehicle 12 issues another command to launch the vehicle-related application 56′. If the vehicle-related application 56′ returns a success response, the application 56 recognizes that the mobile communications device 18 has the vehicle-related application 56′. The in-vehicle application 56 then issues yet another command requesting the vehicle-related application 56′ to return a vehicle-related application identifier for the device's proprietary messaging service. The transmission of the identifier 74 to the application 56 is shown at box 204 of FIG. 2.

Prior to generating the rich message/data package, the application 56 determines whether the vehicle 12 is in park mode or drive mode. The application 56 then generates the rich message/data package. When the application 56 determines that the vehicle 12 is in drive mode, the application 56 may generate the rich message/data package to include the nearest service center's phone number and instructions to launch the mobile communication device's phone dialer application. When the application 56 determines that the vehicle 12 is in park mode, the application may generate the rich message/data packet to include the web URL of the web page of the nearest service center and instructions to launch the mobile communication device's web browser, or include the nearest service center's phone number and instructions to launch the mobile communication device's phone dialer application. In the rich message/data package, the application 56 also includes the mobile communications device phone number.

Once the rich message/data package 78 is generated, the application 56 transmits the rich message/data package 78 to the messaging server 44, as shown at box 206 of FIG. 2.

The messaging server 44 recognizes that the rich message/data package 78 is to be transmitted through the proprietary messaging service, and thus replaces the mobile device phone number with the vehicle-related application identifier, and may add its authentication token to the payload of the rich message/data package 78. The server 44 then passes the rich message/data package 78 to the proprietary messaging server 20, as shown at box 208 of FIG. 2.

The proprietary messaging server 20 authenticates the rich message/data package 78 using the authentication token or the URL of the messaging server, and then identifies the mobile communications device 18 using the vehicle-related application identifier (e.g., the registration ID or the device token). The proprietary messaging server 20 transmits the rich message/data package 78 to the mobile communications device 18, as shown at box 210 in FIG. 2.

While not shown in FIG. 2, it is to be understood that the operating system of the mobile communications device 18 receives the rich message/data package 78, and identifies the vehicle-related application 56′ as the recipient of the rich message/data package 78. The operating system identifies the vehicle-related application 56′ either through the vehicle-related application identifier supplied by the messaging server 44 or by additional information added to rich message/data package 78 by the proprietary messaging server 20. For example, the proprietary messaging server 20 may identify the vehicle-related application 56′ for the operating system by the URL of the messaging server 44. If the vehicle-related application 56′ is not running, the operating system wakes the vehicle-related application 56′ and passes the rich message/data package 78 on to the vehicle-related application 56′.

The vehicle-related application 56′ processes the instructions in the message, and displays the message, launches the device's web browser, or initiates some other device 18 action based on the payload of the rich message/data package 78. For example, if the instructions contain a phone number to the nearest tire shop, the vehicle-related application 56′ would launch the mobile communication device's phone dialer application with the phone number prepopulated from the rich message/data package 78. For another example, if the instructions contain a web URL for the nearest tire shop, the vehicle-related application 56′ would launch the mobile communication device's web browser and go to the web URL provided in the rich message/data package 78.

When the mobile communications device 18 is not connected to the VCP 32 (box 200), the VCP 32 may identify the mobile communications device 18 by transmitting a request to the content server 43 asking for a list of mobile communications devices 18 that have been registered with the user's and/or vehicle's account with the VCP service provider 14. The request may include the authentication token of the user's and/or vehicle's account with the VCP service provider 14, which is available to the application 56 through the vehicle's application programming interface (API).

The content server 43 receives the request, and identifies the user and/or vehicle account from the authentication token. The content server 43 retrieves the list of registered mobile communications device(s) 18 that have the vehicle-related application 56′ installed thereon and have the rich message feature enabled. The content server 43 transmits this list 76 to the application 56, as shown at box 212 in FIG. 2.

The application 56 displays the list 78 on in-vehicle display 58 for the in-vehicle user to select which mobile communications device 18 the message(s) 78 shall be transmitted to. The application 56 receives the user's selection 80 through an input on the display 58 and/or through a button press, as shown at box 214 in FIG. 2.

The method then continues with the application 56 determining the status of the vehicle 12 (i.e., park mode or drive mode), and generating the rich message/data package 78 (box 206). As previously described, the rich message/data package 78 includes the mobile device phone number.

Once the rich message/data package 78 is generated, the application 56 transmits the rich message/data package 78 to the messaging server 44, as shown at box 206 of FIG. 2. The server 44 recognizes that the rich message/data package 78 is to be transmitted through the proprietary messaging service, and thus replaces the phone number with the vehicle-related application identifier, and may add its authentication token in the payload of the rich message/data package 78. The server 44 then passes the rich message/data package 78 to the proprietary messaging server 20, as shown at box 208 of FIG. 2.

The proprietary messaging server 20 authenticates the rich message/data package 78 using the authentication token or the URL of the server 44, and then identifies the mobile communications device 18 using the mobile device identifier. The proprietary messaging server 20 transmits the rich message/data package 78 to the mobile communications device 18, as shown at box 210 in FIG. 2.

While not shown in FIG. 2, it is to be understood that the operating system of the mobile communications device 18 receives the rich message/data package 78, and identifies the vehicle-related application 56′ as the recipient of the rich message/data package 78. The operating system identifies the vehicle-related application 56′ either through the vehicle-related application identifier supplied by the messaging server 44 or by additional information added to rich message/data package 78 by the proprietary messaging server 20. For example, the proprietary messaging server 20 may identify the vehicle-related application 56′ for the operating system by the URL of the messaging server 44. If the vehicle-related application 56′, the operating system wakes the vehicle-related application 56′ and passes the rich message/data package 78 on to the vehicle-related application 56′. The vehicle-related application 56′ processes the instructions in the message, and displays the message, launches the device's web browser, or initiates some other device 18 action based on the payload of the rich message/data package 78.

In another example when the mobile communications device 18 is not connected to the VCP 32 (box 200), the application 56 may generate a QR code containing the vehicle-related information (e.g., the web URL to the video showing how to change the tire or the phone number of a nearby tire service center). This is shown at box 218 in FIG. 2. The QR code 82 embeds the vehicle-related information.

After generating the QR code 82, the application 56 may make a determination as to whether the vehicle 12 is in park mode or drive mode. When the application 56 recognizes that the vehicle 12 is in park mode, the application 56 is programmed to display the QR code on the display 58 for retrieval by the mobile communications device 18, as shown at box 220 in FIG. 2. When the application 56 recognizes that the vehicle 12 is in drive mode, the application 56 is programmed to generate a message indicating that the QR code 82 has been generated, and to display the message on the display 58 (not shown). This message apprises the in-vehicle user that vehicle-related information will be available through the QR code. In these instances, the QR code is temporarily stored in the memory 54. Upon recognizing that the vehicle 12 is no longer in drive mode, the application 56 is capable of retrieving the QR code 82 from the memory 54 and displaying the QR code 82 on the display 58 for retrieval by the mobile communications device 18, as shown at box 220 in FIG. 2.

The user may then use the QR reader application 41 to retrieve the QR code 82 from the vehicle 12, as shown at box 222 in FIG. 2. The QR reader application 41 decodes the QR code 82, and the URL or other vehicle-related information contained therein becomes available for user consumption.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it will be apparent to those skilled in the art that the disclosed examples may be modified. Therefore, the foregoing description is to be considered non-limiting.

What is claimed is:

1. A vehicle-related information sharing method, comprising:
receiving vehicle-related information at an in-vehicle application resident on a memory of a communications platform in a vehicle;
by the in-vehicle application, identifying a mobile communications device to transmit a data package to, the data package being associated with the vehicle-related information;
recognizing, by the in-vehicle application, that the mobile communications device has a vehicle-related application resident on a memory thereof and that the vehicle-related application has a rich message feature enabled;
preparing, by the in-vehicle application, the data package with vehicle-related action information and a phone number of the mobile communications device; and
transmitting the data package from the in-vehicle application to the vehicle-related application first through a messaging server of a communications platform service provider and then through a proprietary messaging server of a proprietary messaging service of the mobile communications device.

2. The vehicle-related information sharing method as defined in claim 1 wherein:
the identifying of the mobile communications device is accomplished by recognizing, by the in-vehicle application, that the mobile communications device is connected to the communications platform through a short range wireless connection; and
the recognizing that the mobile communications device has the vehicle-related application resident on the memory thereof and that the vehicle-related application has the rich message feature enabled is accomplished by receiving, by the in-vehicle application, a vehicle-related application identifier for the proprietary messaging service.

3. The vehicle-related information sharing method as defined in claim 2 wherein subsequent to recognizing that the mobile communications device is connected to the communications platform and prior to receiving the vehicle-related application identifier, the method further comprises:
requesting, from the in-vehicle application, an identity of an operating system of the mobile communications device;
receiving, at the in-vehicle application, the identity of the operating system; and
transmitting, from the in-vehicle application, a command to the mobile device to launch the vehicle-related application.

4. The vehicle-related information sharing method as defined in claim 1 wherein the identifying of the mobile communications device and the recognizing that the mobile communications device has the vehicle-related application and that the vehicle-related application has the rich message feature enabled are accomplished by:
recognizing, by the in-vehicle application, that no mobile communications device is connected to the communications platform;
transmitting, by the in-vehicle application, a request to the messaging server of the communications platform service, the request including an authentication token of a vehicle account;
receiving, in response to the request and by the in-vehicle application, a list of mobile communications devices i) associated with the vehicle, ii) having the vehicle-related application, and iii) having the rich message feature enabled;
by the in-vehicle application, displaying the list on an in-vehicle display; and
receiving, by the in-vehicle application, an input identifying the mobile communications device.

5. The vehicle-related information sharing method as defined in claim 1 wherein the vehicle-related action information includes a Uniform Resource Locator (URL) of a web page, a mobile device command, or a short message that provides a vehicle-related instruction or a vehicle-related action cue.

6. The vehicle-related information sharing method as defined in claim 1 wherein prior to preparing the data package, the method further comprises:
determining, by the in-vehicle application, that the vehicle is in drive mode;
displaying, by the in-vehicle application on an in-vehicle display, only a low cognitive load option;
in response to receiving a user input, generating packaged instructions that enable a low cognitive load function; and
incorporating the packaged instructions in the data package.

7. The vehicle-related information sharing method as defined in claim 6, further comprising:
determining, by the in-vehicle application, that the vehicle is no longer in drive mode;
displaying, by the in-vehicle application on the in-vehicle display, a high cognitive load option;
in response to receiving a user input, generating additional packaged instructions that enable a high cognitive load function; and
transmitting, to the messaging server of the communications platform service provider, for processing and transmission to the mobile communications device, an other data package including the additional packaged instructions.

8. The vehicle-related information sharing method as defined in claim 1 wherein prior to preparing the data package, the method further comprises:
determining, by the in-vehicle application, that the vehicle is not in drive mode;
displaying, by the in-vehicle application on an in-vehicle display, a low cognitive load option and a high cognitive load option;
in response to receiving a user input, generating packaged instructions that enable a low cognitive load function and a high cognitive load function; and
incorporating the packaged instructions in the data package.

9. The vehicle-related information sharing method as defined in claim 1 wherein the transmitting of the data package includes:
transmitting the data package from the in-vehicle application to the messaging server of the communications platform service provider;
then transmitting the data package, a vehicle-related application identifier retrieved by the messaging server of the communications platform service provider, and an authentication token from the messaging server of the communications platform service provider to the proprietary messaging server;
by the proprietary messaging server, authenticating the authentication token; and
then transmitting the data package and the vehicle-related application identifier from the proprietary messaging server to the mobile communications device.

10. The method as defined in claim 9, further comprising:
by an operating system of the mobile communications device, using the vehicle-related application identifier to identify the vehicle-related application;
when the vehicle-related application is not then-currently running, causing the vehicle-related application to run; and
passing the data package to the vehicle-related application.

11. A vehicle-related information sharing system, comprising:
a vehicle communications platform; and
an in-vehicle application embodied in a non-transitory, tangible computer readable medium, the in-vehicle application including computer readable instructions executable by a processor of the in-vehicle communications platform, the computer readable instructions for:
receiving vehicle-related information;
identifying a mobile communications device to transmit a data package to, the data package being associated with the vehicle-related information;
recognizing that the mobile communications device has a vehicle-related application resident on a memory thereof and that the vehicle-related application has a rich message feature enabled;
preparing the data package with vehicle-related action information and a phone number of the mobile communications device; and
transmitting the data package to the vehicle-related application first through a messaging server of a communications platform service provider and then through a proprietary messaging server of a proprietary messaging service of the mobile communications device.

12. The vehicle-related information sharing system as defined in claim 11, further comprising:
the mobile communications device;
the messaging server of the communications platform service; and
the proprietary messaging server of a proprietary messaging service.

13. A vehicle-related information sharing method, comprising:
recognizing, at an in-vehicle application resident on a memory of a communications platform in a vehicle, that a mobile communications device is not connected to the communications platform;
receiving, at the in-vehicle application, vehicle-related action information;
preparing, at the in-vehicle application, a quick response code with the vehicle-related action information; and
displaying the quick response code on an in-vehicle display for decoding by the mobile communications device.

14. The vehicle-related information sharing method as defined in claim 13 wherein prior to displaying the quick response code, the method further comprises:
determining, by the in-vehicle application, that the vehicle is in drive mode;
generating, by in-vehicle application, a message indicating that a quick response code is available;
displaying the message on the in-vehicle display; and
temporarily storing the quick response code.

15. The vehicle-related information sharing method as defined in claim 14, further comprising:
determining, by the in-vehicle application, that the vehicle is no longer in drive mode;
retrieving the quick response code from a temporary storage for display on an in-vehicle display for decoding by the mobile device.

16. The vehicle-related information sharing method as defined in claim 13 wherein prior to displaying the quick response code, the method further comprises determining, by the in-vehicle application, that the vehicle is not in drive mode.

17. A vehicle-related information sharing method, comprising:
by the in-vehicle application, identifying a mobile communications device to transmit a data package to;
recognizing, by the in-vehicle application, that the mobile communications device has a vehicle-related application resident on a memory thereof and that the vehicle-related application has a rich message feature enabled;
preparing, by the in-vehicle application, a first data package with vehicle-related action information and an identification number of the mobile communications device;
transmitting the first data package from the in-vehicle application to a messaging server of a communications platform service provider; and
then transmitting a second data package responsive to the first data package to the vehicle-related application of the mobile communications device, wherein the second data package contains vehicle-related information in a context determined by the first data package.

18. The vehicle-related information sharing method as defined in claim 17, further comprising transmitting a third data package from the in-vehicle application to the vehicle-related application.
